(19) United States
(12) Patent Application Publication
(10) Pub. No.: US 2005/0213775 A1
(43) Pub. Date: Sep. 29, 2005

(54) Sound source transmitting device

(76) Inventor: Ming-Yuan Wong, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/075,693

(22) Filed: Mar. 10, 2005

(30) Foreign Application Priority Data
Mar. 29, 2004 (TW) 093108572

(51) Int. Cl. H04B 3/00; H01R 33/945

(52) U.S. Cl. 381/77; 439/577

(57) ABSTRACT

A sound source transmitting device includes a sound source plug, which has a main terminal and parallel auxiliary terminals at the front side and a cable at the back side, which main terminal has a front tip, and a sound source socket, which has a main plughole for receiving the main terminal and a plurality of auxiliary plugholes for receiving the auxiliary terminals, and a switch disposed at a back side of the main plughole and controllable by the front tip of the main terminal to selectively set between a stereo sound source signal output for stereo sound source signal output through the main plughole and a multi-channel sound source signal output for multi-channel sound source signal output through the main plughole and the auxiliary plugholes.

### FIELD OF THE INVENTION

The present invention relates to a sound source transmitting device, and more particularly to a multi-channel sound source plug and corresponding socket thereof for enlarging the applicative field of the sound source device.

### BACKGROUND

A sound source transmitting device is generally comprised of a sound source plug and a sound source socket. Upon insertion of the sound source plug into the sound source socket, sound source signal is transmitted from the sound source socket to the sound source plug and then through the cable of the sound source plug to a speaker or the like that converts sound source signal into audible sound.

FIG. 1 illustrates a conventional sound source plug 10 used with a headphone 51. The sound source plug 10 comprises a housing 15, a cable 17 extended from the rear side of the housing 15 and electrically connected to the speakers 511, 512 of the headphone 51, and a cylindrical terminal 11 forwardly protruded from the front side of the housing 15. The cylindrical terminal 11 has a plurality of contact electrodes 111, 113, 115. The contact electrodes 111, 113, 115 are connectable to the first channel contact electrode, the second channel contact electrode, and the grounding electrode. Therefore, this design of sound source plug 10 is practical for transmitting a sound source signal of two channels only.

Following fast development of information technology, a variety of audio and video apparatus have been developed. Regular audio video storage medium, magnetic disks, video tapes, DVD, and etc. provide the function of a multi-channel surrounding sound effect. For example, a sound source signal may be set to provide 5 channels, 5.1 channels, 6 channels, 7 channels, including the left channel, the right channel, the central channel, the rear left channel, the rear right channel, the extra low frequency channel, and etc. International sound source designs are numerous, including Dolby Pro Logic, Dolby Digital (Dolby AC-3), DTS (Digital Theater System), SDDS (Sony Dynamic Digital Sound), THX, and etc. In order to fit multi-channel sound source output, multi-channel sound source transmitting devices are developed. FIG. 2 illustrates a prior art design of multi-channel sound source plug 20 used with a headphone 51. According to this design, the multi-channel sound source plug 20 comprises a housing 25, a cable 27 extended from the back side of the housing 25 and electrically connected to the multiple speakers 511˜516 of the headphone 51, a main terminal 21 forwardly extended from the front side of the housing 25 at the center, and two auxiliary terminals 23, 24 forwardly extended from the front side of the housing 25 and equally spaced from the main terminal 21 at two sides. The main terminal 21 comprises a plurality of contact electrodes 211˜215, which includes a first channel contact electrode, a second channel contact electrode, and a grounding electrode. The auxiliary terminals 23, 24 comprise a plurality of contact electrodes 231, 233, 242, 244 for transmitting sound source signal from the third channel to the sixth channel.

The aforesaid multi-channel sound source plug 20 must be used with a specially designed multi-channel sound source socket. It is not connectable to a conventional stereo sound source socket. Therefore, the application of the aforesaid multi-channel sound source plug 20 is limited. Further, a multi-channel sound source socket fitting the aforesaid multi-channel sound source plug 20 is not practical for use with a stereo sound source plug. When inserted a stereo sound source plug into a multi-channel sound source socket fitting the aforesaid multi-channel sound source plug 20, the stereo sound source plug can only receive two main channels of the discriminated multi-channel sound source signal, but cannot receive stereo sound source signal, therefore the received sound effect is incomplete and not natural.

Therefore, it is desirable to provide a sound source transmitting device that eliminates the aforesaid drawbacks.

### SUMMARY OF THE INVENTION

The present invention has been accomplished under the circumstances in view. It is therefore the main object of the present invention to provide a sound source transmitting device, which allows output of stereo sound source signal as well as multi-channel sound source signal from a sound source to an audio output device. It is another object of the present invention to provide a sound source transmitting device, which uses a switch in the sound source socket thereof to control different sound source signal outputs. It is still another object of the present invention to provide a sound source socket for sound source transmitting device, which fits different sound source plugs. It is still another object of the present invention to provide a sound source plug for sound source transmitting device, which fits different sound source sockets. To achieve these and other objects of the present invention, the sound source transmitting device comprises a sound source plug, the sound source plug comprising a main terminal and a plurality of auxiliary terminals, the main terminal having a front tip axially forwardly extended from a front side thereof; and a sound source socket adapted to receive the sound source plug, the sound source socket comprising a main plughole adapted to receive the main terminal of the sound source plug, a plurality of auxiliary plugholes adapted to receive the auxiliary terminals of the sound source plug, and switch means disposed at a back side of the main plughole and controllable by the front tip of the main terminal of the sound source plug to selectively set between a stereo sound source signal output for signal output through the main plughole and a multi-channel sound source signal output for signal output through the main plughole and the auxiliary plugholes. Further, the auxiliary terminals of the sound source plug are biasable so that the sound source plug is connectable to different sound source sockets.

### BRIEF DESCRIPTION OF DRAWINGS

FIG. 1 illustrates a sound source plug according to the prior art.

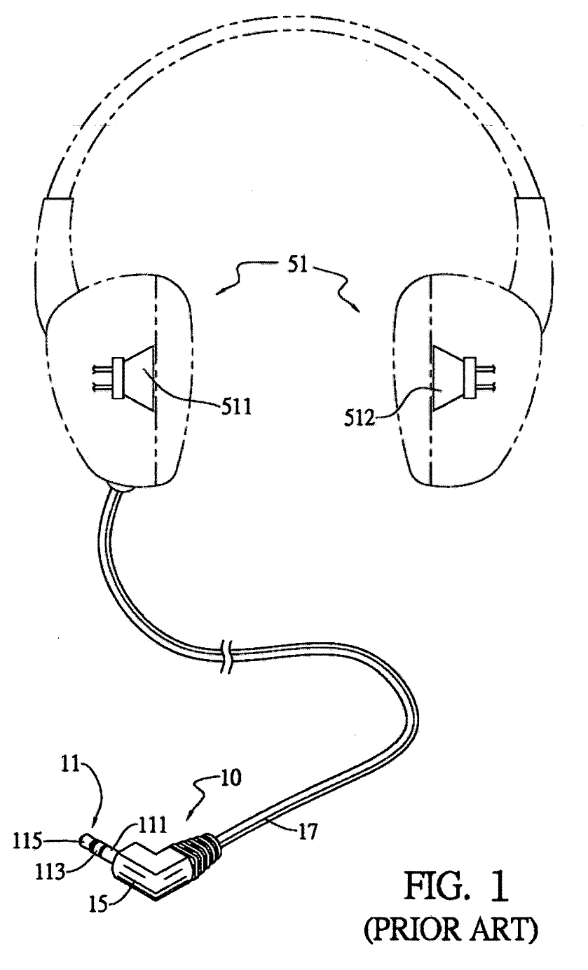

FIG. 2 illustrates another structure of sound source plug according to the prior art.

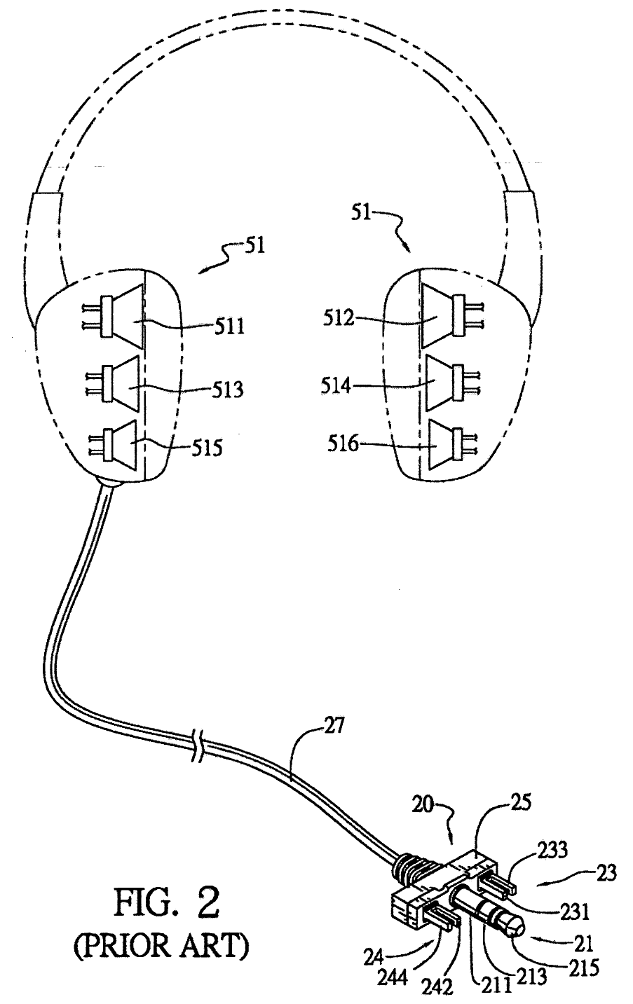

FIG. 3 is an exploded view of a sound source transmitting device according to the present invention.

FIG. 4 is a schematic drawing showing the sound source plug connected to a headphone through an amplifier.

FIG. 5 illustrates a status of use of the present invention.

FIG. 6 is a perspective view of an alternate form of the present invention.

FIG. 7 illustrates another alternate form of the present invention.

FIG. 8 is a perspective view of still another alternate form of the present invention.

FIG. 9 is a perspective view of still another alternate form of the present invention.

### DETAILED DESCRIPTION

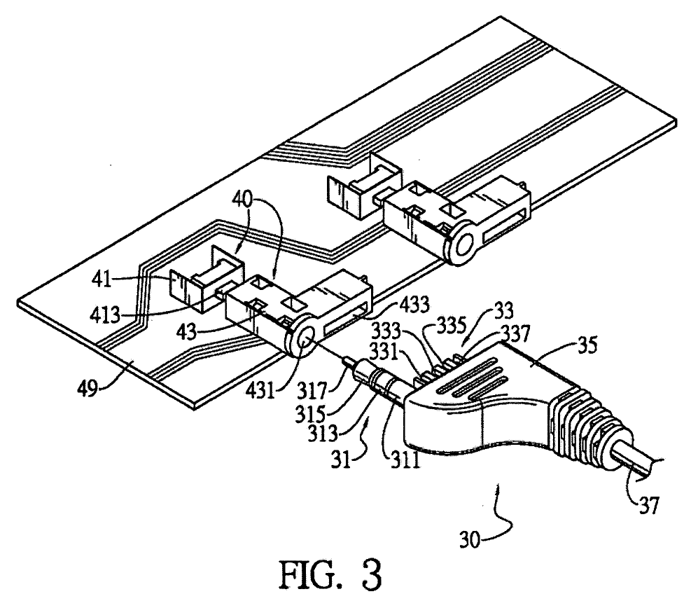

Referring to FIG. 3, a sound source transmitting device in accordance with the present invention is shown comprised of a sound source plug 30 and a sound source socket 40.

The sound source plug 30 is shown comprising a housing 15, a main terminal 31 and an auxiliary terminal 32 forwardly extended from one side, namely, the front side of the housing 15, and a cable 37 backwardly extended from the other side, namely, the rear side of the housing 15. The main terminal 31 is a cylindrical member comprising at least three contact electrodes, namely, the front contact electrode 311, the intermediate contact electrode 313 and the rear contact electrode 315, and a front tip 317 axially forwardly extended from the front end of the front contact electrode 311. The auxiliary terminal 33 is comprises of a plurality of auxiliary contact electrodes 331, 333, 335, 337 arranged in parallel.

The sound source socket 40 comprises a socket body 43 and a switch 41. The socket body 43 comprises a main plughole 431 and an auxiliary plughole 433 adapted to receive the main terminal 31 and auxiliary terminal 32 of the sound source plug 30 respectively. The switch 41 comprises a press button 413. The sound source socket 40 is normally installed in a circuit board 49, which is mounted inside an audio/video apparatus, for example, a radio, a mobile CD player, CD/VCD/DVD player, or the like.

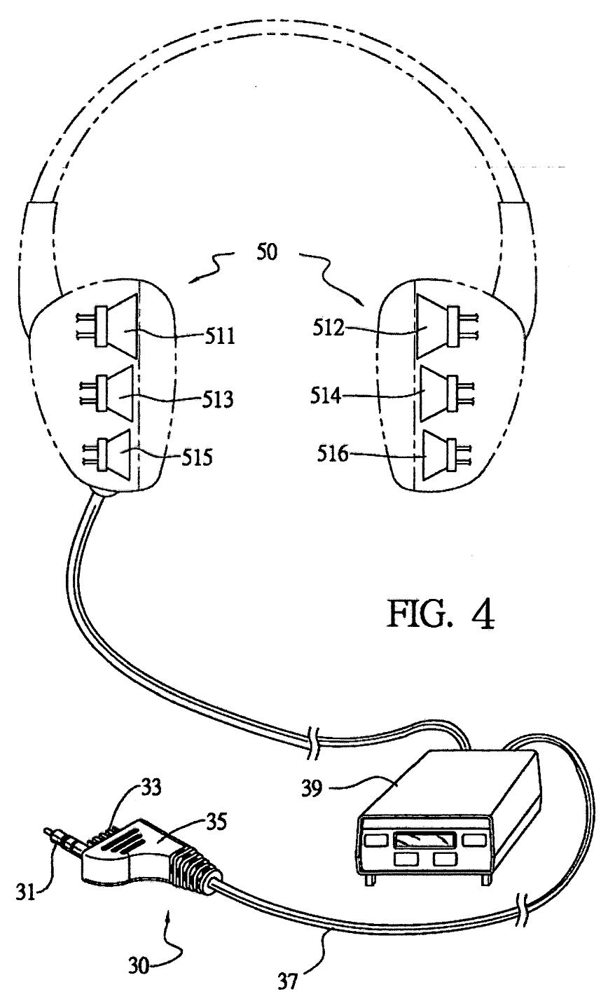

FIG. 4 illustrates an application example of the present invention. As illustrated, the cable 37 of the sound source plug 30 is connected to the input port of an amplifier 39, and an audio output device, for example, a headphone 50 is connected to the output port of the amplifier 39. The headphone 50 comprises multiple pairs of speakers 511˜516. After connection of the cable 37 of the sound source plug 30 to the amplifier 39 (alternatively, the cable 37 may be directly connected to the headphone 50), the front contact electrode 311 and intermediate contact electrode 313 of the main terminal 31 and the auxiliary contact electrodes 331, 333, 335, 337 of the auxiliary terminal 33 are respectively electrically connected to the speakers 511˜516 (see also FIG. 3).

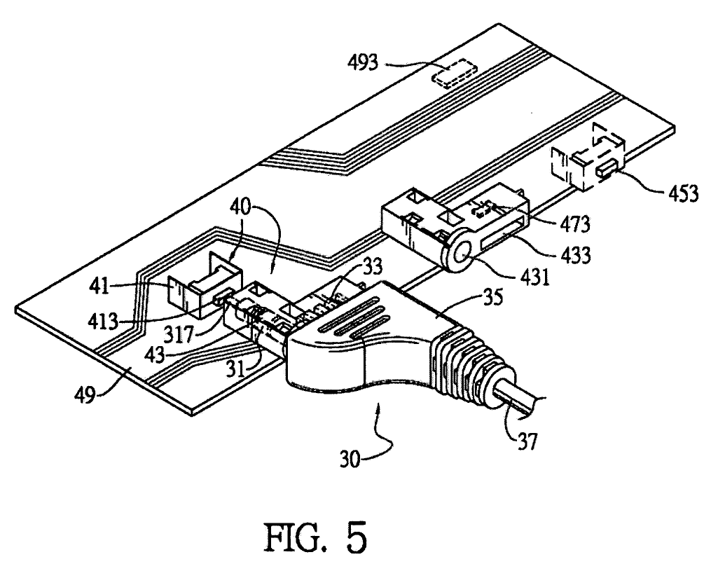

Referring to FIG. 5, upon connection of the sound source plug 30 to the sound source socket 40, the front tip 317 is pressed on the press button 413 to cause the switch 41 to provide a signal to the circuit board 49, thereby driving the circuit board 49 to execute or set a multi-channel sound source signal transmission function, and therefore sound source signals of five channels, 5.1 channels, or six channels including the left channel, the right channel, the central channel, the rear left channel, the rear right channel, and the extra low frequency channel are transmitted through the main plughole 431 and auxiliary plughole 433 of the socket body 43 and the main terminal 31 and auxiliary terminal 32 of the sound source plug 30 to the amplifier 39 and then the speakers 511˜516 of the headphone 50.

According to the aforesaid embodiment, the circuit board 49 (or the control unit of the audio/video apparatus) determines main channel (stereo) sound source signal output or multi-channel sound source signal output subject to the position (pressing status) of the press button 413. In an alternate form of the present invention, the switch 453 of the sound source socket is provided at one peripheral side of the circuit board 49 for manual control. The user can switch the switch 453 between two positions manually, driving the circuit board 49 to select main channel (stereo) sound source signal output or multi-channel sound source signal output (see also FIG. 5). In another alternate form of the present invention, a detecting device 473 is installed in the auxiliary plughole 433 of the sound source socket and adapted to detect the presence of the auxiliary terminal 33 in the auxiliary plughole 433. The detecting device 473 can be a mechanical device, or an electronic sensor or optical sensor. Upon detection of the presence of the auxiliary terminal 33 in the auxiliary plughole 433, the detecting device 473 immediately gives a signal to the circuit board 49, driving the circuit board 49 to select the discriminated multi-channel sound source signal output. On the contrary, if the detecting device 473 detects no signal, the circuit board 49 selects the encoded and mixed main channel (stereo) sound source output (see also FIG. 5). In still another alternate form, a control device 493 is installed in the circuit board 49, and controlled by an external signal input device, for example, a mouse, keyboard, button, or remote controller to select multi-channel or stereo sound source signal output (see also FIG. 5).

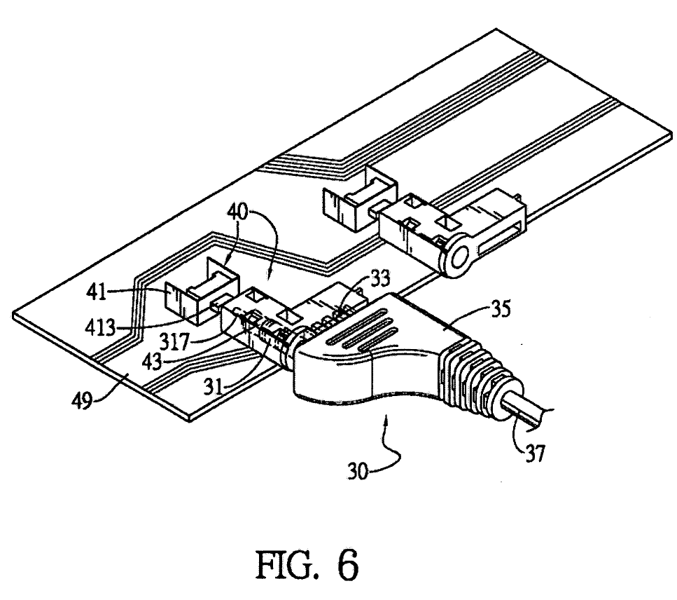

Referring to FIG. 6, when inserted the sound source plug 30 into the sound source socket 40 partially without causing the front tip 317 to press the press button 413 of the switch 41, the circuit board 49 or the control device 493 immediately selects standard sound mix (for example, DownMix) stereo sound source signal output, enabling stereo sound source signal to be transmitted through the main plughole 431 of the socket body 43 and the main terminal 31 of the sound source plug 30 to the output device (for example, the aforesaid headphone). At this time, the auxiliary plughole 433 gives no signal output.

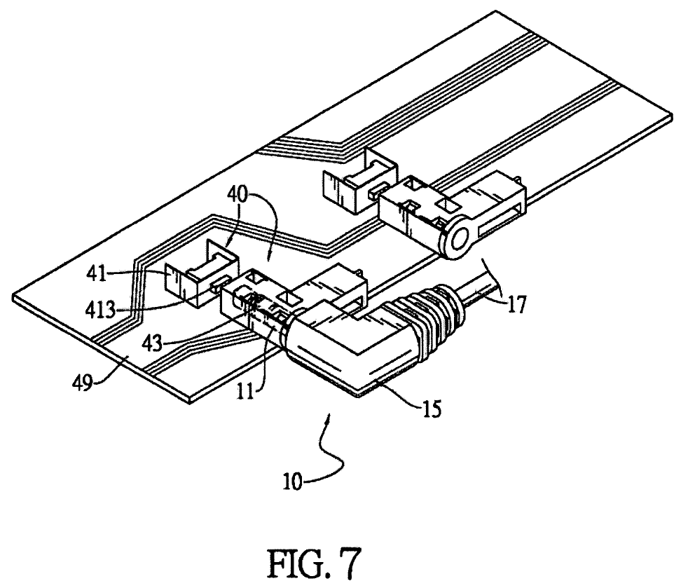

Referring to FIG. 7, the sound source socket 40 of the present invention can be used with a conventional sound source plug 10, which comprises a housing 15, a terminal 11 at one end of the housing 15, and a cable 17 at the other end of the housing 15. Upon insertion of the sound source plug 10 into the sound source socket 40, the terminal 11 of the sound source plug 10 does not touch the press button 413 of the switch 41, and therefore the circuit board 49 or the control device 493 selects standard sound mix (for example, DownMix) stereo sound source signal output. Therefore, stereo sound source signal is outputted through the main plughole 431 of the socket body 43 and the main terminal 31 of the sound source plug 30 to the output device (for example, the aforesaid headphone), and the auxiliary plughole 433 gives no signal output.

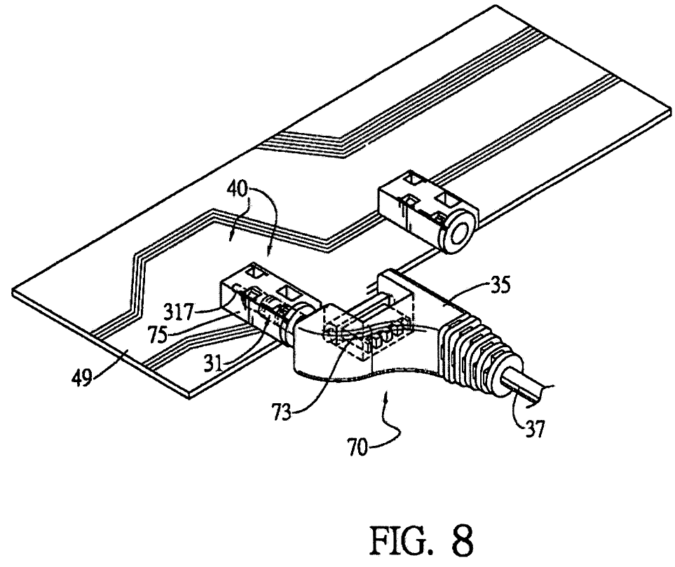

FIG. 8 shows still another alternate form of the present invention. According to this embodiment, the sound source plug, referenced by 70 is substantially similar to the embodiment shown in FIG. 3 with the exception of the design of the auxiliary terminals 73. According to this embodiment, the auxiliary terminals 73 are biasable so that the sound source plug 70 is connectable to a conventional sound source socket that has only one single cylindrical plughole for stereo output. Alternatively, the auxiliary terminals 73 can be made retractable.

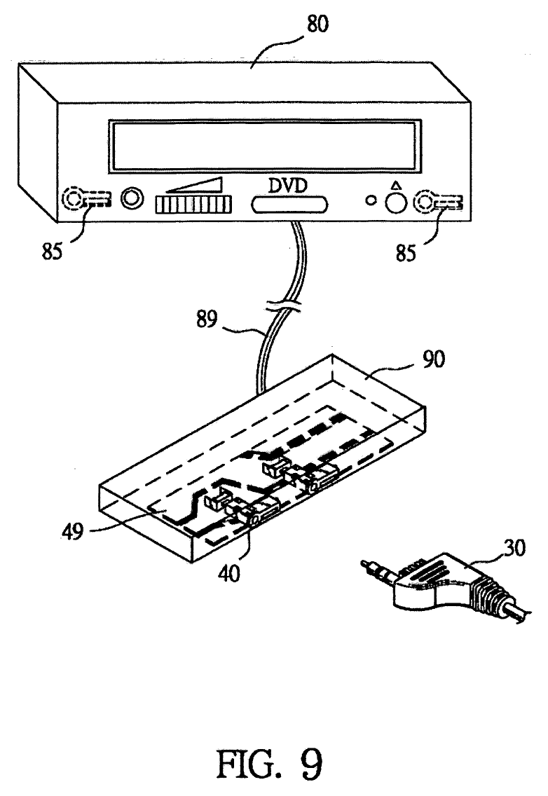

FIG. 9 shows still another alternate form of the present invention. According to this embodiment, the circuit board 49 and the sound source socket 40 are installed in an adapter 90, which has a signal line 89 connected to a sound source 80. The signal line 89 can be a coaxial cable or fiber optic. Alternatively, infrared or microwave transmitter receiver means may be used to substitute for the signal line 89. The sound source 80 can be a CD/VCD/DVD player, MP3 player, game machine, PDA, or mobile computer. The adapter 90 is used with the sound source plug 30 for stereo and multi-channel sound source signal output.

The sound source 80 has a sound source socket 85. The sound source plug 30 can be directly connected to the sound source socket 85 of the sound source 80 for signal output.

In the aforesaid embodiments, the auxiliary terminals 33 are arranged in parallel at one side of the main terminal 31. Alternatively, the auxiliary terminals 33 can be arranged in two sets at two sides of the main terminal 31.

A prototype of sound source transmitting device has been constructed with the features of FIGS. 3˜9. The sound source transmitting device functions smoothly to provide all of the features discussed earlier.

Although the present invention has been explained in relation to its preferred embodiments, it is to be understood that many other possible modifications and variations can be made without departing from the spirit and scope of the invention as hereinafter claimed.

1. A sound source transmitting device, comprising:
a sound source plug, provided a main terminal and a plurality of auxiliary terminals, said main terminal having a front tip axially forwardly extended from a front side thereof; and
a sound source socket adapted to receive said sound source plug, said sound source socket comprising a main plughole adapted to receive the main terminal of said sound source plug, a plurality of auxiliary plugholes adapted to receive the auxiliary terminals of said sound source plug, and switch means disposed at a back side of said main plughole and controllable by said front tip of said main terminal of said sound source plug to selectively set between a stereo sound source signal output for signal output through said main plughole and a multi-channel sound source signal output for signal output through said main plughole and said auxiliary plugholes.

2. The sound source transmitting device as claimed in claim 1, wherein said switch means comprises a press button, controllable by said front tip of said main terminal of said sound source plug to switch, said switch means between said first output mode and said second output mode.

3. The sound source transmitting device as claimed in claim 1, wherein said main terminal is provided a plurality of main contact electrodes, and said auxiliary terminals are provided a plurality of auxiliary contact electrodes.

4. The sound source transmitting device as claimed in claim 1, wherein said sound source plug is connected to speaker means for transmitting sound source signal to said speaker means through a cable.

5. The sound source transmitting device as claimed in claim 4, wherein said cable of said sound source plug is further connected to said speaker means through an amplifier.

6. The sound source transmitting device as claimed in claim 1, wherein said auxiliary terminals are biasable.

7. The sound source transmitting device as claimed in claim 1, wherein said sound source socket is selectively provided in an audio/video player and an adapter connectable to an audio/video player.

8. A sound source transmitting device, comprising:
a sound source socket provided a main plughole for stereo sound source signal output and a plurality of auxiliary plugholes for multi-channel sound source signal output; and
switch means controllable by a set signal to selectively set between a stereo sound source signal output for signal output through said main plughole and a multi-channel sound source signal output for signal output through said main plughole and said auxiliary plugholes.

9. The sound source transmitting device as claimed in claim 8, wherein said switch means is a press button provided at a rear side of said main plughole.

10. The sound source transmitting device as claimed in claim 8, wherein said switch means is a sensor provided in said at least one auxiliary terminal of said sound source socket and adapted to detect the presence of auxiliary terminal means of a sound source plug in said auxiliary plughole.

11. The sound source transmitting device as claimed in claim 8, wherein said switch means is a control device provided in a circuit board.

12. The sound source transmitting device as claimed in claim 8, wherein said switch means is formed of one of a group of devices including a mechanical switch, an electronic sensor, and an optical sensor.

13. The sound source transmitting device as claimed in claim 8, wherein said sound source socket is selectively provided in an audio/video player and an adapter connectable to an audio/video player.

14. The sound source transmitting device as claimed in claim 8, further comprising a sound source plug, provided a main terminal and a plurality of auxiliary terminals arranged in parallel at a front side thereof and respectively connectable to said main plughole and said auxiliary plugholes, and a cable extended from a rear side thereof and connected to speaker means.

15. The sound source transmitting device as claimed in claim 14, wherein said auxiliary terminals of said sound source plug are biasable.

16. The sound source transmitting device as claimed in claim 14, wherein said main terminal of said sound source plug is provided a front tip axially forwardly extended from a front side thereof and adapted to switch said switch means upon insertion of said main terminal into said main plughole.

17. A sound source transmitting device comprising a sound source plug, provided a main terminal and at least one auxiliary terminals, wherein said main terminal comprises a plurality of a plurality of main contact electrodes, said at least one auxiliary terminal comprising a plurality of auxiliary contact electrodes, said at least one auxiliary terminal being bias able.
